(19) United States
(12) Patent Application Publication
(10) Pub. No.: US 2009/0309869 A1
(43) Pub. Date: Dec. 17, 2009

(54) Driving circuit and display

(75) Inventor: Kengo Umeda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/457,553

(22) Filed: Jun. 15, 2009

(30) Foreign Application Priority Data
Jun. 16, 2008 (JP) 2008-156782

(51) Int. Cl. G06F 3/038; G09G 3/36

(52) U.S. Cl. 345/214; 345/87

(57) ABSTRACT

A liquid crystal display in which it is possible to reduce the EMI noise ascribable to high harmonic contents in a charging/discharging current is disclosed. The liquid crystal display includes a source driver 10. The source driver includes output terminals (OUTn) that drive a liquid crystal panel, amplifiers 15 that amplify a video signal and output switching circuits 17 each connected between an output of the amplifier 15 and the output terminal. The source driver also includes an output switch impedance control circuit 16 that controls the switching operation of the output switching circuits 17. When turned on during the operation of switching the output switching circuit 17, the output switch impedance control circuit 16 exercises control to progressively lower the impedance of the output switching circuit 17.

### REFERENCE TO RELATED APPLICATION

This application is based upon and claims the benefit of the priority of Japanese patent application No. 2008-156782, filed on Jun. 16, 2008, the disclosure of which is incorporated herein in its entirety by reference thereto.

### TECHNICAL FIELD

This invention relates to a driving circuit and a display. More particularly, it relates to a driving circuit adapted to reduce the EMI (Electro-Magnetic Interference) and to a display making use of such circuit.

### BACKGROUND

A liquid crystal display (LCD) is used in a wide range of application, such as office automation (OA), domestic appliances or industrial appliances, as a flat panel display indispensable for the era of information communication, in order to take advantage of its thin thickness, light weight and low power usage. In general, a liquid crystal driving IC (liquid crystal driving circuit) including a gray scale potential generation circuit, a decoding circuit, an amplifier and so forth is arranged in this liquid crystal display. The gray scale potential generation circuit generates a plurality of gray scale potentials. The decoding circuit selects one of the gray scale potentials in response to a video data signal. The gray scale potential, selected by the decoding circuit, is put to current amplification by the amplifier, and the resulting signal is afforded over a data line to a liquid crystal cell.

Meanwhile, with increase in the size of the liquid crystal display, the capacitance loaded on the data line tends to be increased. Hence, a higher value of the charging/discharging current is needed. The charging/discharging current flows simultaneously to the entirety of outputs of the liquid crystal driving IC, thus producing an acute peak current and a significant EMI noise.

As a technique for reducing the EMI noise, there is disclosed in Patent Document 1 a driving circuit that shifts output timings of a plurality of latch pulses to decrease the peak current.

FIG. 11 depicts the formulation of a driving circuit shown in Patent Document 1. In FIG. 11, a display data holding section 105 holds a selection pulse signal XSP, a clock signal XCLK and display data XDn, and delivers the display data XDn it holds to latch circuits 106a, 106b. The latch circuits 106a, 106b latch the display data XDn at respective timings of two picture output control signals XSTB1, XSTB2, delivered from outside within the same horizontal period, and outputs the so latched display data XDn to a D/A converter 107. The D/A converter transforms the display data XDn to an analog signal, which is then output via output buffers 108a, 108b to picture signal output terminals 109a, 109b.

The driving circuit, formulated as described above, shifts the on-timing of output switches for odd outputs of the display data XDn by At with respect to that for their even outputs, as shown in FIG. 12. This allows decreasing the power supply current IDD corresponding to the peak value of the charging/discharging current of the pixels of the liquid crystal display, and hence the EMI noise, otherwise increased with increase in the power supply current IDD.

### [Patent Document 1]

JP Patent Kokai Publication No. JP2006-267999A

### SUMMARY

The disclosure of the above Patent Document is incorporated herein by reference thereto. Now, the following analyses are given by the present invention.

The following analysis is made from the side of the present invention.

With the conventional technique, peak values of the power supply current, attendant on the onset of the charging/discharging current, may be decreased. However, there still persists acute rising in the charging/discharging current. The charging/discharging current is produced once during the horizontal period, with the fundamental frequency component being as low as approximately 50 kHz. However, since high harmonics are contained in the acutely rising charging/discharging circuit, these high harmonics are actually presented as EMI noise, with a result that the EMI noise in the MHz band, composed of the high harmonics, is increased. FIG. 5B shows the results of analysis by FFT (Fast Fourier Transform) of the conventional technique. It is seen from this figure that, although the fundamental frequency component of the charging/discharging current is approximately 50 kHz, the current contains a great deal of high harmonics of 10 MHz to 1 GHz which present problems as EMI noise.

In one aspect, the present invention provides a driving circuit comprising an output terminal, an amplifier circuit that amplifies a picture signal, an output switching circuit connected between an output of the amplifier circuit and the output terminal, and an impedance control circuit that exercises control to vary impedance of the output switching circuit progressively in operation of switching of the output switching circuit.

The meritorious effects of the present invention are summarized as follows.

According to the present invention, high harmonic components in the charging/discharging current may be reduced by progressively varying the impedance of the output switching circuit to prohibit acute changes in the charging/discharging current. It is thus possible to reduce the EMI noise ascribable to the high harmonic components in the charging/discharging current.

### BRIEF DESCRIPTION OF THE DRAWINGS

FIG. 1 is a circuit diagram showing a formulation of a liquid crystal display according to Example 1 of the present invention.

FIG. 2 is a circuit diagram showing a formulation of a source driver according to Example 1 of the present invention.

FIG. 3A is a circuit diagram showing a formulation of an output switch impedance control circuit according to Example 1 of the present invention.

FIG. 3B is a timing diagram of the output switch impedance control circuit according to Example 1 of the present invention.

FIG. 4 is a timing chart showing waveforms at various parts of the source driver according to Example 1 of the present invention.

FIG. 5A is a graph showing the results of analysis by FFT (fast Fourier transform) of the charging/discharging currents of the present invention.

FIG. 5B is a graph showing the results of analysis by FFT (fast Fourier transform) of the charging/discharging currents of a conventional technique.

FIG. 6 is a circuit diagram showing a formulation of a source driver according to Example 2 of the present invention.

FIG. 7 is a diagrammatic view showing the relationship among the power supply voltage, common voltage and the gray scale potentials in the liquid crystal display according to Example 2 of the present invention.

FIG. 8 is a schematic view showing a formulation of an output switch impedance control circuit according to Example 2 of the present invention.

FIG. 9 is a timing chart showing waveforms at various parts of the output switch impedance control circuit according to Example 2 of the present invention.

FIG. 10 is a timing chart showing waveforms at various parts of a source driver according to Example 2 of the present invention.

FIG. 11 is a circuit diagram showing a formulation of a driving circuit disclosed in Patent Document 1.

FIG. 12 is a timing chart for illustrating the operation of the driving circuit disclosed in Patent Document 1.

### PREFERRED MODES

A driving circuit according to an exemplary embodiment of the present invention includes an output terminal, an amplifier circuit that amplifies a picture signal, an output switching circuit connected between an output of the amplifier circuit and the output terminal and an impedance control circuit that controls the switching operation of the output switching circuit. The impedance control circuit exercises control to progressively vary the impedance of the output switching circuit during the switching operation of the output switching circuit. It is particularly preferred to exercise control to progressively lower the impedance when the output switching circuit is turned on.

In a driving circuit according to the present invention, the output switching circuit may be formed by an FET, and the impedance control circuit applies a control voltage that will progressively lower the on-resistance of the FET to a gate end of the FET when the switch circuit is turned on.

In a driving circuit according to the present invention, the impedance control circuit may include a constant current source circuit, and a switching device that selects an output current from the constant current source circuit or a power supply voltage to deliver the output current or the power supply voltage selected to the gate end of the FET.

In a driving circuit according to the present invention, the impedance control circuit may include: a voltage generation circuit that delivers a plurality of respective different voltages; a selection circuit that selects the voltages one-by-one to deliver each voltage selected to the gate end of the FET; and a timing control circuit that affords to the selection circuit a plurality of selection signals that sequentially select the multiple voltages one-by-one so as to progressively lower an on-resistance of the FET.

In a driving circuit according to the present invention, the impedance control circuit may include a gray scale potential generation circuit that generates a plurality of gray scale voltage signals for generating the picture signal. The voltage generation circuit forms a part of said gray scale potential generation circuit and selects the multiple voltages from the multiple gray scale voltage signals to output the so selected voltage(s).

In another aspect, the present invention provides a display including any one of the above driving circuits and a display panel driven by the driving circuit.

With the display of the present invention, in which the impedance of the output switching circuit is progressively lowered to prohibit acute rising of the charging/discharging current, high harmonic components of the charging/discharging current may be reduced. It is thus possible to reduce the EMI noise ascribable to the high harmonic components of the charging/discharging current.

Examples of the present invention is now described with reference to the drawings.

### EXAMPLE 1

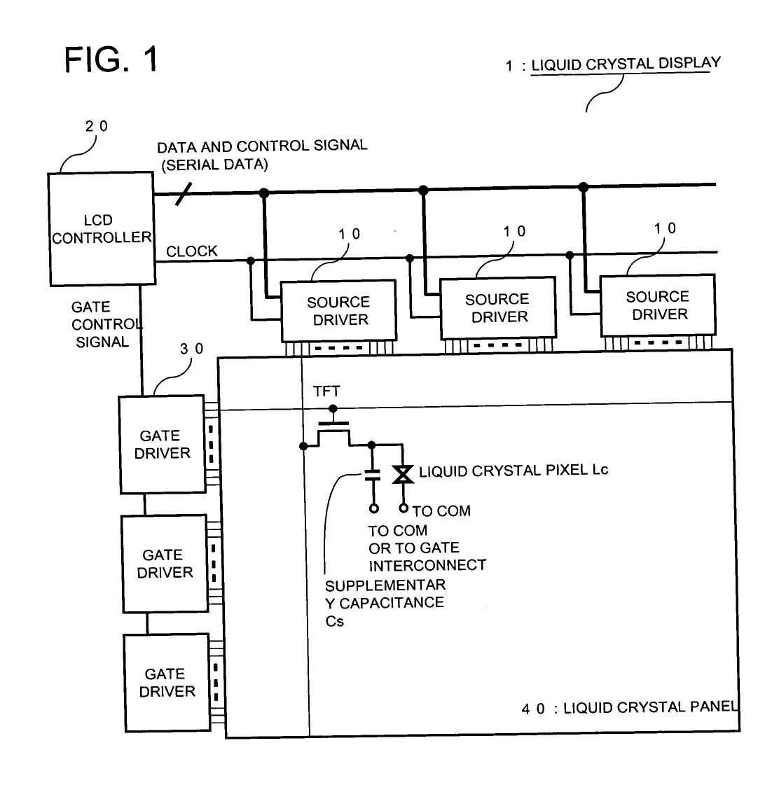

FIG. 1 shows a formulation of a liquid crystal display according to Example 1 of the present invention. Referring to FIG. 1, a liquid crystal display 1 includes a plurality of source drivers 10, a timing controller (LCD controller) 20, a plurality of gate drivers 30 and a liquid crystal display panel 40. It is observed that each source driver 10 comprises a source side liquid crystal driver IC and each gate driver comprises a gate side liquid crystal driver IC.

The LCD controller 20 sends a clock and serial data, composed of data (video data) and a control signal, to the source driver 10, while sending a gate control signal to the gate drivers 30, respectively. Each thin-film transistor TFT, provided within the liquid crystal display panel 40, has a source driven by the associated source driver 10, while having a gate driven by the associated gate driver 30. The drain of each TFT is connected via a liquid crystal pixel (liquid crystal part) Lc and a supplementary capacitance Cs to a common wiring COM.

With the above-described formulation of the liquid crystal display 1, the TFT, selected by the source driver 10 and the gate driver 30, drives a liquid crystal pixel Lc with a signal corresponding to data (video data) to drive the liquid crystal pixel Lc for display.

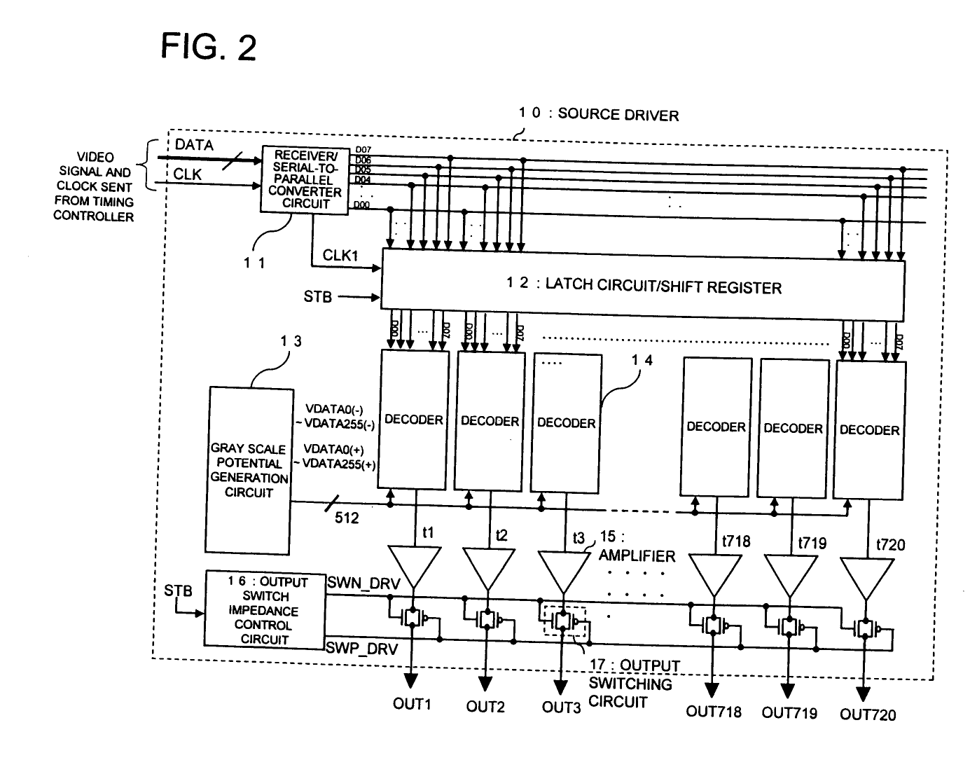

FIG. 2 shows a formulation of a source driver according to Example 1 of the present invention. The source driver 10 is an 8-bit source side liquid crystal driving IC, and includes a receiver/serial-to-parallel converter circuit 11, a latch circuit/shift register 12, a gray scale potential generation circuit 13, decoders 14, amplifiers (amplification circuits) 15, an output switch impedance control circuit 16 and output switching circuits 17.

The receiver/serial-to-parallel converter circuit 11 receives a clock CLK and a serial video data signal DATA, sent from the LCD (timing) controller 20, and converts the signal into pixel-based parallel data D00 to D07.

The latch circuit/shift register 12 sequentially transfers the parallel data D00 to D07, obtained on conversion by the receiver/serial-to-parallel converter circuit 11, with the clock signal CLK1, to transfer data corresponding to one gate signal line. These parallel data D00 to D07 are latched in synchronism with a latch pulse signal STB and retained as a number of digital gray scale data corresponding to the number of outputs.

The decoder 14 inputs gray scale potentials VDATA0(+) to VDATA255(+) and VDATA0(−) to VDATA255(−), and selects, from input VDATA0(+) to VDATA255(+) or VDATA0(−) to VDATA255(−), a gray scale voltage corresponding to the digital data D00 to D07, as sent from the latch circuit/shift register 12, from output to output. It is observed that the gray scale potentials VDATA0(+) to VDATA255(+) and VDATA0(−) to VDATA255(−) are generated by the gray scale potential generation circuit 13 and output to the decoders 14. It is also observed that, within the decoder 14, the gray scale potentials VDATA0(+) to VDATA255(+) and VDATA0(−) to VDATA255(−) are shared by the outputs of the same polarities. Specifically, the gray scale potentials VDATA0(+) to VDATA255(+) are shared by the outputs of the positive polarity, while the gray scale potentials VDATA0(−) to VDATA255(−) are shared by the outputs of the negative polarity.

If the number of the outputs is 720, as an example, the gray scale voltages of the respective outputs, as selected by the decoder 14, are output to inputs t1 to t720 of respective amplifiers 15 which are provided from output to output. All of the amplifiers 15 charge or discharge data lines OUT1 to OUT720, in synchronism with falling of the latch pulse signal STB, to deliver selected potentials via the data lines to respective pixels of the liquid crystal cells.

The output switch impedance control circuit 16 outputs control signals SWN_DRV and SWP_DRV to the output switching circuit 17, in synchronism with the latch pulse signal STB, to control the impedance of the output switching circuit 17.

The output switching circuit 17 is formed by a transfer gate composed of a parallel connection of two FETs of opposite conductivity types, for instance. The control signals SWN_DRV and SWP_DRV are delivered to the gates of the two FETs. The output switching circuit 17 disconnects an output of each amplifier 15 from an associated one of the data lines OUT1 to OUT720 for a preset time duration based on the levels of the control signals SWN_DRV and SWP_DRV.

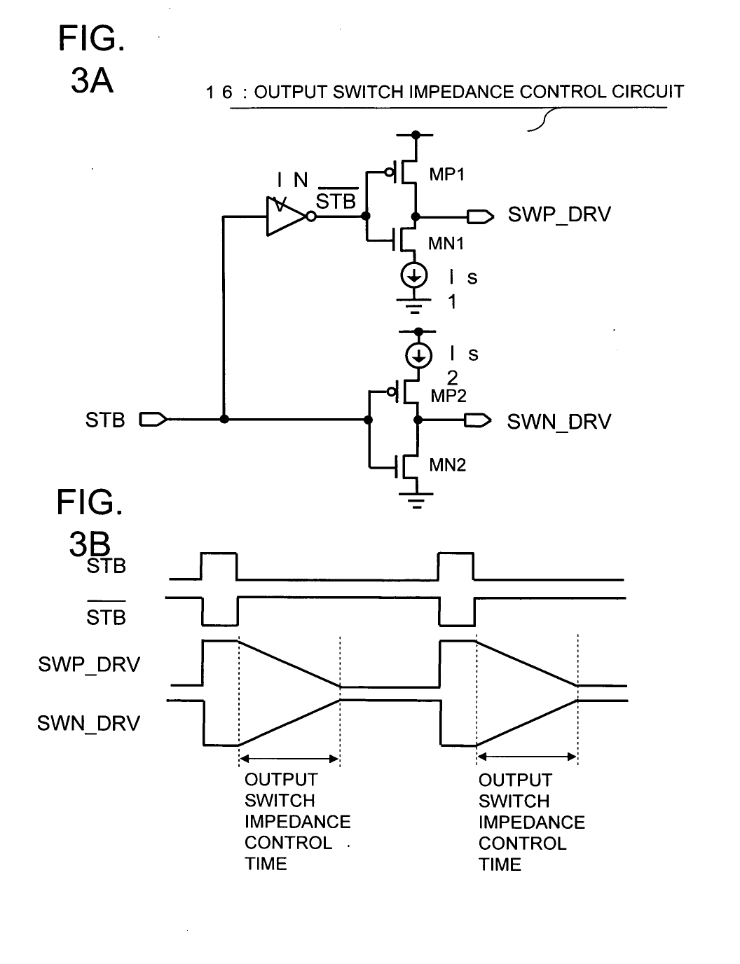

FIGS. 3A and 3B respectively show a schematic circuit diagram and a timing diagram of the output switch impedance control circuit according to Example 1 of the present invention. Referring to FIG. 3A, the output switch impedance control circuit 16 includes an inverter circuit INV, NMOS transistors MN1, MN2, PMOS transistors MP1, MP2 and current source circuits Is1, Is2. A latch pulse signal STB is delivered to the gates of the PMOS transistor MP2 and the NMOS transistor MN2. The inverter circuit INV inverts the signal level of the latch pulse signal STB to deliver the so inverted signal level to the gates of the PMOS transistor MP1 and the NMOS transistor MN1. The PMOS transistor MP1 has a source connected to a power supply, while having a drain connected to a drain of the NMOS transistor MN1. The NMOS transistor MN1 has a source grounded via the current source circuit Is1. The PMOS transistor MP2 has a source connected to a power supply via the current source circuit Is2, while having a drain connected to a drain of the NMOS transistor MN2, whose source is grounded.

With the above-described output switch impedance control circuit 16, when the latch pulse signal STB is brought HIGH in level, the PMOS transistor MP1 and the NMOS transistor MN2 are turned on, as shown in FIG. 3B. Hence, the voltage level of the signal SWP-DRV at the drain of the PMOS transistor MP1 becomes the power supply level, while that of the signal SWN_DRV at the drain of the NMOS transistor MN2 becomes the GND level.

If the latch pulse signal STB then is changed to the LOW level, the PMOS transistor MP1 and the NMOS transistor MN2 are turned off, while the NMOS transistor MN1 and the PMOS transistor MP2 are turned on. Hence, the electrical charges stored at a control end of the output switching circuit 17 (at the FET's gate) are discharged via the current source circuit Is1, and hence the potential of the signal SWP-DRV progressively falls to the GND level. On the other hand, the electrical charges discharged at the other control end of the output switching circuit 17 are charged via the current source circuit Is2, and hence the potential of the signal SWN-DRV progressively rises to the power supply level. Hence, the waveforms of the signals SWP_DRV and SWN_DRV become ramp waveforms shown in FIG. 3B.

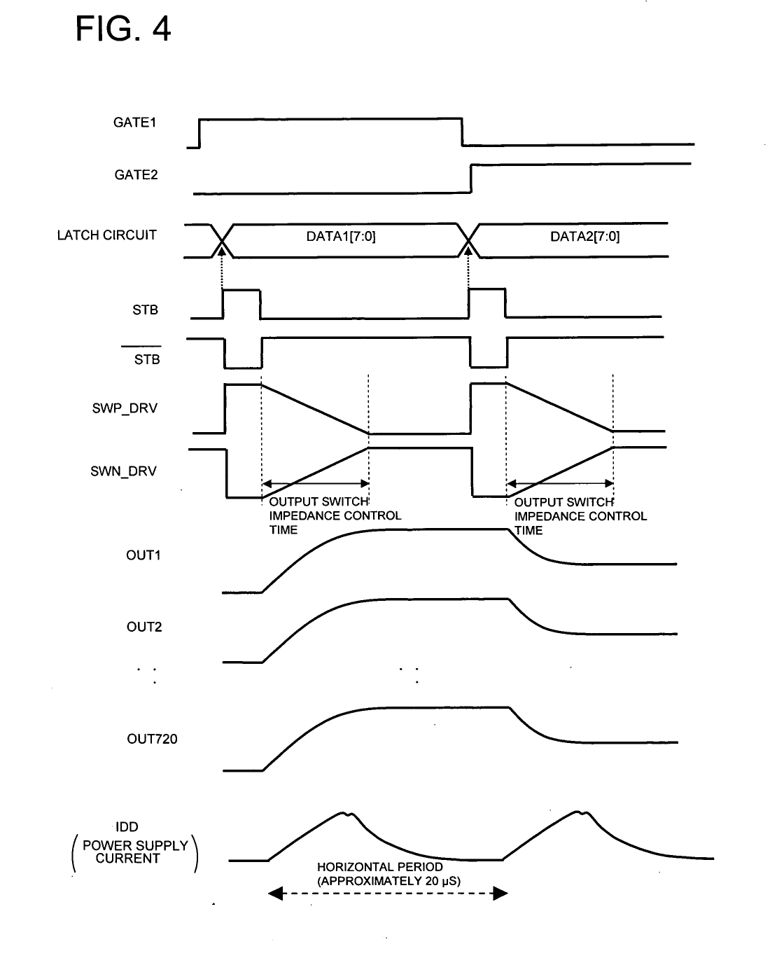

The operation of the source driver 10 is now described. FIG. 4 depicts a timing chart of respective parts of the source driver according to Example 1 of the present invention. The latch pulse signal STB goes HIGH in synchronism with gate driving signals GATE1, GATE2 and so forth, output from the gate drivers 30. Digital video data, that is, 8-bit DATA1 [7:0], DATA2 [7:0] and so forth, are written in the latch circuit/shift register 12 at a rising edge of the latch pulse signal STB. An analog voltage, matched to the so written digital video data, is selected by the decoder 14 and delivered as output to an input end of the amplifier 15. At this time, the signals SWP_DRV, SWN_DRV, presenting ramp waveforms as from the time of falling of the latch pulse signal STB during the output switch impedance controlling time, are delivered by the output switch impedance control circuit 16 to the output switching circuit 17. Thus, the waveforms at outputs OUT1 to OUT720 of the output switching circuit 17 are moderately rising/falling signals, as shown in FIG. 4. Hence, a power supply current IDD, mainly at the amplifiers 15, is of such a waveform that undergoes a moderate transition with a horizontal period (approximately 20 Ps, e.g.) as a period.

The above-described output switch impedance controlling time may be fixed, or may also be dynamically changed every vertical scanning period or from frame to frame. Also, in the above Example, the waveform for decreasing the impedance (resistance component) of the output switch is the ramp waveform. This is not restrictive such that any suitable waveform that will ultimately render the resistance value to a minimum value may be used. To optimize the favorable effect, monotonously transitioning waveforms are preferred.

With the source driver 10, described above, the high harmonic contents of the power supply current may be reduced by progressively lowering the impedance of the output switch to prohibit acute rising and falling of the power supply current of the liquid crystal device. It is thus possible to decrease the EMI noise generated as a result of the high harmonic contents of the power supply current. If the output switch controlling time, shown in FIG. 3B, is selected to be longer, it becomes possible to further reduce the high harmonic contents and hence the EMI noise.

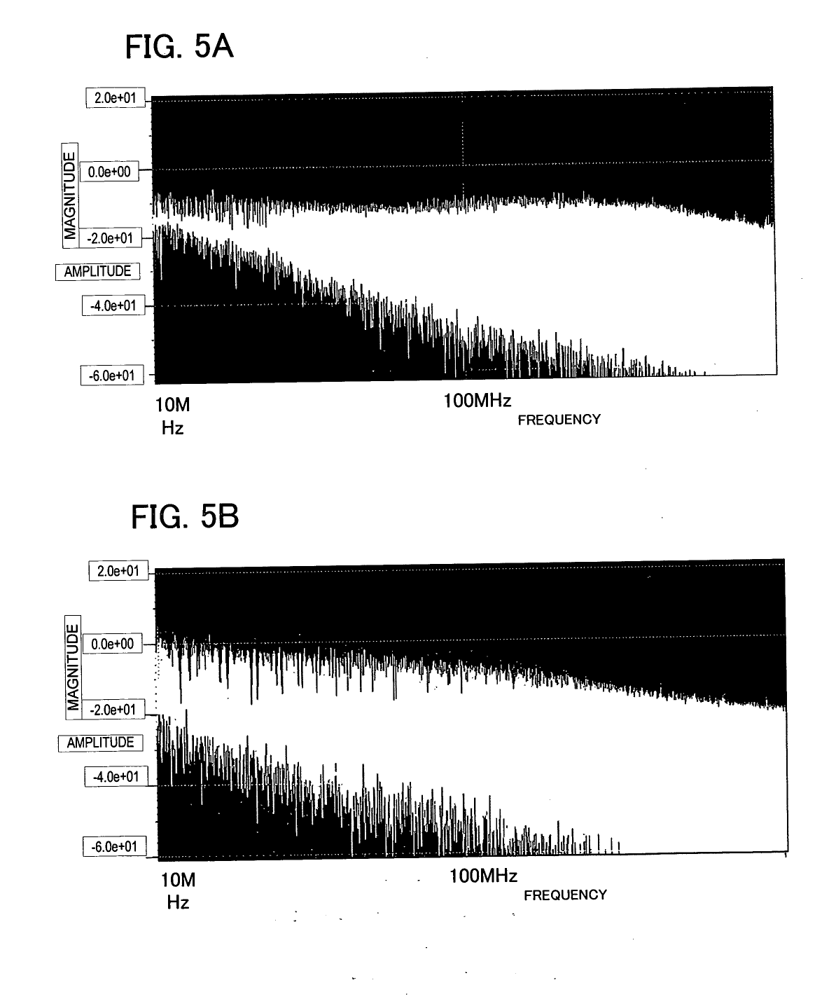

FIG. 5A shows an instance of analysis by FFT (fast Fourier transform) of the charging/discharging current in the driving circuit of the present invention. It is seen from FIG. 5A that, according to the present invention, the high harmonic components in the vicinity of 10 MHz to 50 MHz may appreciably be reduced in comparison with those with the conventional technique shown in FIG. 5B. It is observed that, in FIGS. 5A and 5B, the scale units of amplitude on the respective ordinates are the same.

### EXAMPLE 2

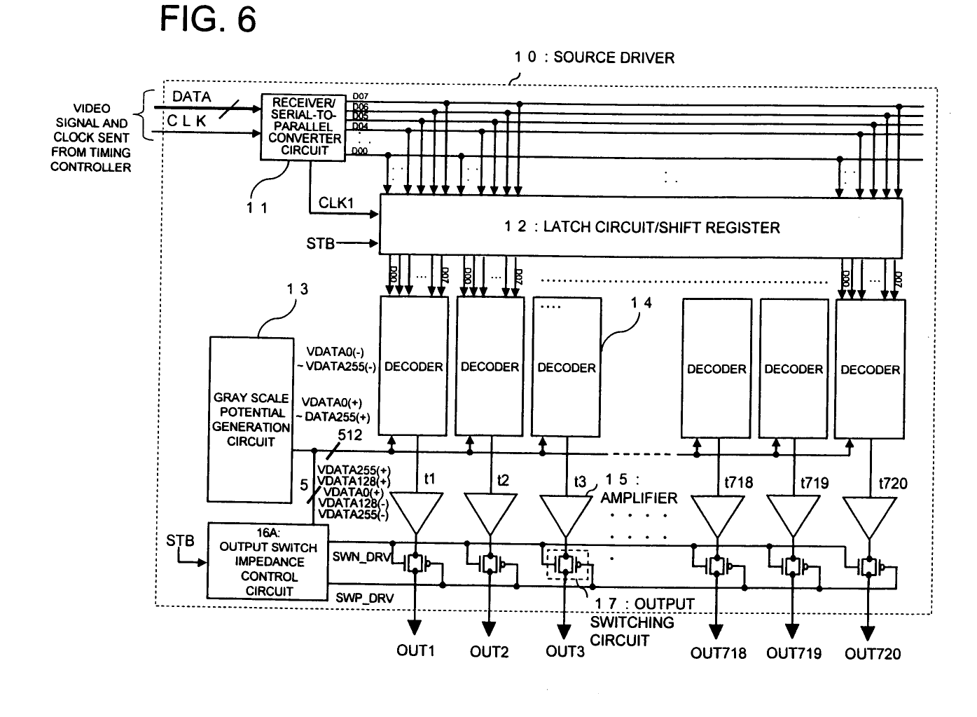

FIG. 6 shows a formulation of a source driver in Example 2 of the present invention. The source driver shown in FIG. 6 differs from the source driver of Example 1 in that some of the gray scale voltages, which are VDATA255(+), VDATA128(+), VDATA0(+), VDATA128(−) and VDATA255(−) in the present Example, are delivered to an output switch impedance control circuit 16A. Using these input multiple gray scale voltages, the output switch impedance control circuit 16A generates a stepped waveform within the output switch impedance controlling time to control the impedance of the output switching circuit 17 stepwise.

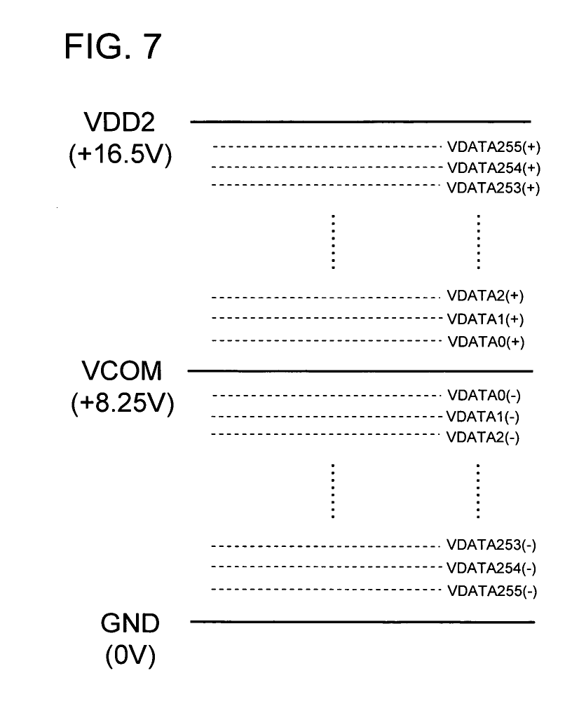

FIG. 7 shows the relationship among the power supply voltage, a common voltage and the gray-scale potentials in a normally black type liquid crystal display, in which the common voltage (VCOM) is fixed.

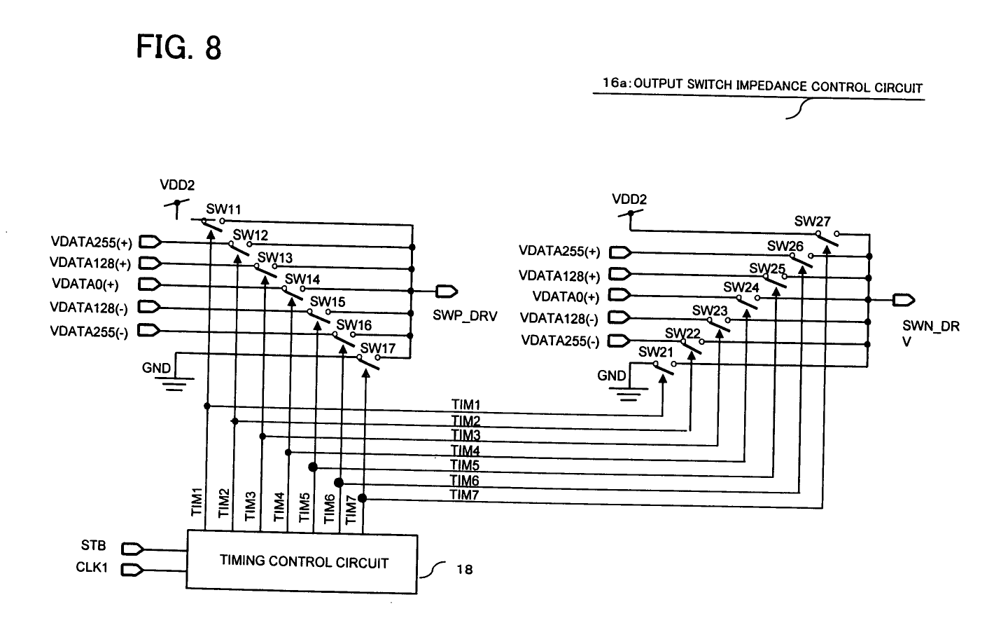

FIG. 8 depicts a circuit diagram of an output switch impedance control circuit according to Example 2 of the present invention. The output switch impedance control circuit 16A includes a timing control circuit 18 and gray scale potential selection switches SW11 to SW17 and SW21 to SW27.

The gray scale potential selection switches SW11 to SW17 have one ends respectively connected to a power supply VDD2, gray scale potentials VDATA255(+), VDATA128(+), VDATA0(+), VDATA128(−) and VDATA255(−) and to the ground GND, while having the other ends connected common to output a signal SWP_DRV. The gray scale potential selection switches SW21 to SW27 have one ends respectively connected to the ground GND, VDATA255(−), VDATA128(−), VDATA0(+), VDATA128(+) and VDATA255(+) and to the power supply VDD2, while having the other end connected common to output a signal SWN_DRV.

The timing control circuit 18 inputs a latch pulse signal STB and a clock signal CLK1 to generate control pulses TIM1 to TIM7 that respectively control the on/off of the gray scale potential selection switches SW11 to SW17 and that also respectively control the on/off of the gray scale potential selection switches SW21 to SW27. The control pulses TIM1 to TIM7 are supplied to control ends of the gray scale potential selection switches SW11 to SW17, respectively, and also to control ends of the gray scale potential selection switches SW21 to SW27, respectively.

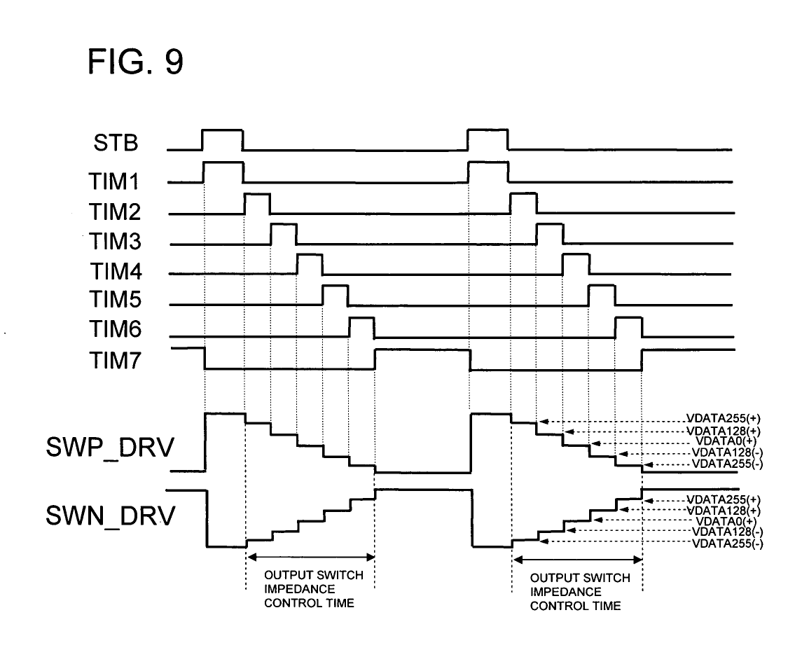

FIG. 9 depicts a timing chart of an output switch impedance control circuit of Example 2 of the present invention. The control pulse TIM1 goes HIGH in synchronism with the latch pulse signal STB. Then, during the output switch impedance controlling time, the control pulses TIM2 to TIM6 are sequentially brought HIGH, in synchronism with the clock signal CLK1, as from the falling timing of the latch pulse signal STB. At the same time as the control pulse TIM6 goes LOW, the control pulse TIM7 is kept HIGH in level until the next rising of the latch pulse signal STB. By the control pulses TIM1 to TIM7, thus generated, the gray scale potential selection switches SW11 to SW17 are sequentially turned on to generate a signal SWP_DRV the potential of which is decreased stepwise. On the other hand, the gray scale potential selection switches SW21 to SW27 are sequentially turned on to generate a signal SWN_DRV the potential of which is increased stepwise.

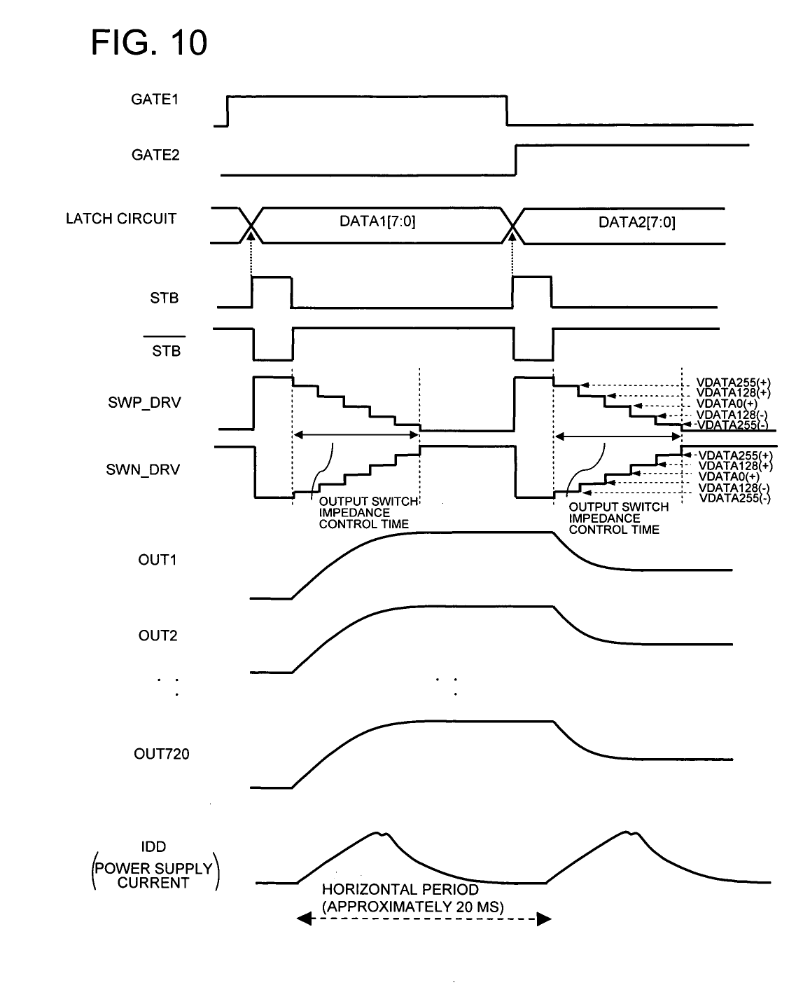

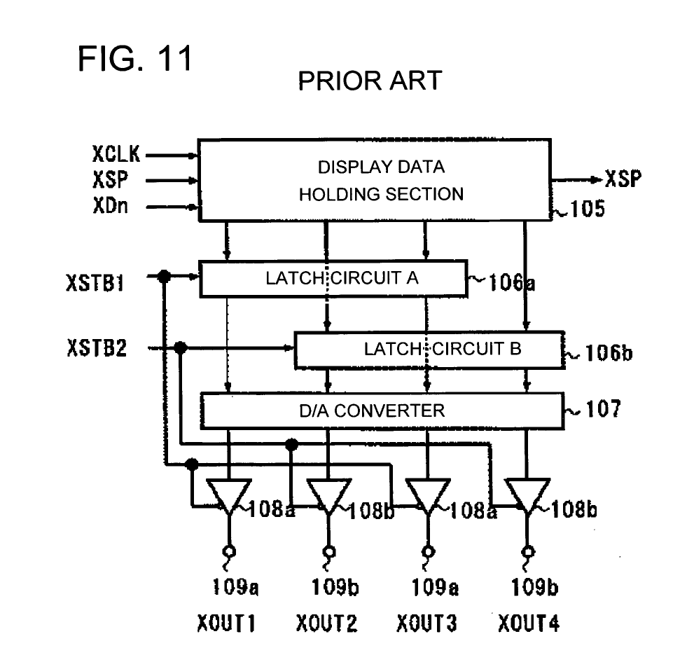

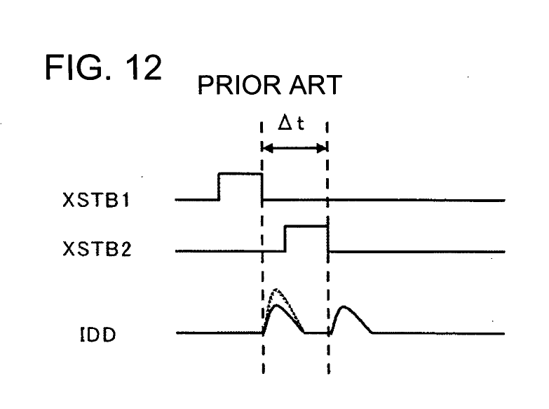

FIG. 10 depicts a timing chart of respective parts of the source driver according to Example 2 of the present invention. The difference of the formulation of FIG. 10 from that of FIG. 4 is that the signals SWP_DRV and SWN_DRV are stepped in waveform, these signals SWP_DRV and SWN_DRV controlling the output switch impedance stepwise. With the source driver of the present Example, as with that of Example 1, the power supply current IDD in the amplifier 15 undergoes moderate transitions with the horizontal period (approximately 20 μs, e.g.) as a period.

In the above Example, it is assumed that five gray scale voltages, namely VDATA255(+), VDATA128(+), VDATA0(+), VDATA128(−) and VDATA255(−), are delivered to the output switch impedance control circuit. This is not restrictive such that the number of the gray scale voltages may be other than five. The gray scale levels need not be separated from each other by the same interval, that is, the interval between the neighboring gray scale levels may be selected arbitrarily. The output switch impedance controlling time may be fixed or dynamically changed every vertical period or from one frame to another.

In Example 1, the ramp waveform is generated by a current source of an impedance controlling circuit. The impedance controlling time at the output switch is thus determined by the current value of the current source of the impedance control circuit and the gate capacitance at the output switch, and hence there is some difficulty in controlling it at high accuracy. With the present Example, the impedance control time of the output switch may be controlled to high accuracy based on the number of the gray scale potentials and the number of control pulses.

The foregoing description is made with reference to a ‘liquid crystal display (LCD)’. However, the display is not limited to the liquid crystal display and may encompass other types of the displays driven in like manner.

The disclosure of the aforementioned Patent Document 1 is incorporated by reference herein. The particular exemplary embodiments or examples may be modified or adjusted within the gamut of the entire disclosure of the present invention, inclusive of claims, based on the fundamental technical concept of the invention. Further, variegated combinations or selection of elements disclosed herein may be made within the framework of the claims. That is, the present invention may encompass various modifications or corrections that may occur to those skilled in the art in accordance with the within the gamut of the entire disclosure of the present invention, inclusive of claim and the technical concept of the present invention.

What is claimed is:

1. A driving circuit comprising:
an output terminal;
an amplifier circuit that amplifies a picture signal;
a switching circuit connected between an output of said amplifier circuit and said output terminal; and an impedance control circuit that exercises control to vary impedance of said switching circuit progressively in operation of switching of said switching circuit.

2. The driving circuit according to claim 1, wherein said impedance control circuit exercises control to lower the impedance of said switching circuit progressively when said switching circuit is turned on.

3. The driving circuit according to claim 2, wherein said switching circuit is formed by FET, and wherein
said impedance control circuit applies a control voltage that will progressively lower the on-resistance of said FET to a gate end of said FET when said switch circuit is turned on.

4. The driving circuit according to claim 3 wherein said impedance control circuit includes:
a constant current source circuit; and
a switching device that selects and delivers an output current from said constant current source circuit or a power supply voltage to said gate end of said FET.

5. The driving circuit according to claim 3, wherein said impedance control circuit includes:
a voltage generation circuit that delivers a plurality of respective different voltages;
a selection circuit that selects said voltages one-by-one to deliver each voltage selected to said gate end of said FET; and
a timing control circuit that affords to said selection circuit a plurality of selection signals that sequentially select said multiple voltages one-by-one so as to progressively lower on-resistance of said FET.

6. The driving circuit according to claim 5 further comprising:
a gray scale potential generation circuit that generates a plurality of gray scale voltage signals for generating said picture signal;
said voltage generation circuit forming a part of said gray scale potential generation circuit; said voltage generation circuit selecting said multiple voltages from said multiple gray scale voltage signals to output the so selected voltages.

7. A display comprising:
the driving circuit according to claim 1; and
a display panel driven by said driving circuit.
